(19) United States
(12) Patent Application Publication
(10) Pub. No.: US 2007/0053629 A1
(43) Pub. Date: Mar. 8, 2007

(54) Providing a Subsea Optical Junction Assembly for Coupling Fiber Optic Cables

(75) Inventors: Ramaswamy Meyyappan, Sugar Land, TX (US); Roderick MacKenzie, Rueil Malmaison (FR); Michael Birch, Aberdeenshire, Scotland (GB); Gregor E. Deans, Oxfordshire (GB)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 11/467,206

(22) Filed: Aug. 25, 2006

Related U.S. Application Data
(60) Provisional application No. 60/596,154, filed on Sep. 2, 2005.

(51) Int. Cl. G02B 6/26

(52) U.S. Cl. 385/15

(57) ABSTRACT

A system for use in a subsea environment includes at least one fiber optic cable for connection to surface equipment, and a subsea optical junction assembly connected to the at least one fiber optic cable. The system further includes subsea components, and plural fiber optic cables connected to corresponding subsea components. The subsea optical junction assembly couples the at least one fiber optic cable for connection with the surface equipment to the plural fiber optic cables connected to the subsea components.

### CROSS-REFERENCE TO RELATED APPLICATION

This claims the benefit under 35 U.S.C. § 119(e) of U.S. Provisional Application No. 60/596,154, entitled “Fiber Optic Coupler”, filed Sep. 2, 2005, which is hereby incorporated by reference.

### TECHNICAL FIELD

The present invention relates generally to use of a subsea optical junction assembly for coupling fiber optic cables.

### BACKGROUND

Subsea well equipment typically includes wellhead equipment provided on a sea floor (or sea bed) for controlling fluid production and/or injection in a respective subsea wellbore. Subsea wellhead equipment can be associated with a subsea acquisition and/or control system (for acquiring measured data associated with a subsea wellbore or the subsea environment and/or to control various aspects of the subsea wellbore).

To communicate between surface equipment (such as equipment located on sea vessels or platforms at the sea surface or onshore) and the subsea acquisition and/or control system, an umbilical line is typically run between the surface equipment and the subsea acquisition and/or control system. The umbilical line usually encloses hydraulic control lines and electrical cables. In some implementations, a fiber optic cable can also be provided in the umbilical line to enable optical communication between the surface equipment and the subsea acquisition and/or control system.

In a typical subsea configuration with multiple subsea applications (such as multiple subsea acquisition and/or control systems or other types of systems) that utilize optical communications, multiple corresponding umbilical lines are provided. Having to deploy multiple umbilical lines in a subsea environment can be costly. Also, conventionally, to add a new subsea application that utilizes optical communication, an additional umbilical line that includes a fiber optic cable has to be deployed. Thus, conventional configurations do not allow for easy addition of subsea optical applications.

### SUMMARY

In general, a subsea optical junction assembly is provided to couple fiber optic cables in a subsea environment.

Other or alternative features will become apparent for the following description, from the drawings, and from the claims.

### BRIEF DESCRIPTION OF THE DRAWING

FIG. 1 illustrates an example configuration including a subsea optical junction assembly, according to an embodiment.

FIG. 2 illustrates another example configuration including a subsea optical junction assembly, according to another embodiment.

FIG. 3 illustrates details of the subsea optical junction assembly, according to an embodiment.

FIG. 4 is another depiction of the subsea optical junction assembly.

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

As used here, the terms “up” and “down”; “upper” and “lower”; “upwardly” and downwardly”; “upstream” and “downstream”; “above” and “below”; and other like terms indicating relative positions above or below a given point or element are used in this description to more clearly described some embodiments of the invention. However, when applied to equipment and methods for use in wells that are deviated or horizontal, such terms may refer to a left to right, right to left, or other relationship as appropriate.

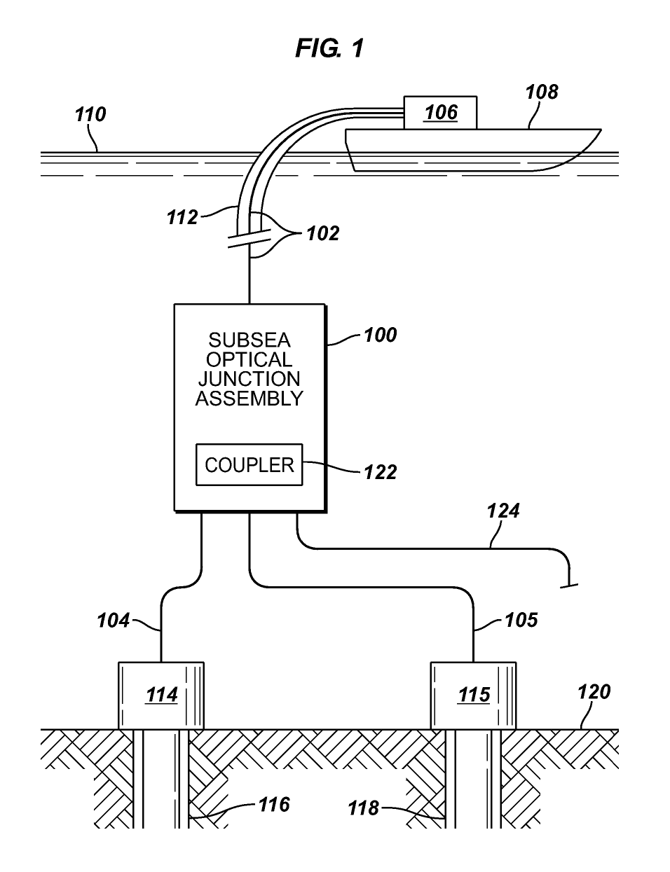

FIG. 1 illustrates an example configuration of a subsea system that includes a subsea junction assembly 100 (more specifically a subsea optical junction assembly) that couples at least one fiber optic cable 102 (connected to surface equipment 106) to plural subsea fiber optic cables 104, 105 (connected to corresponding underwater systems 114, 115). The term “fiber optic cable” refers to any cable that is capable of communicating optical signals along a length of the cable. In addition, although reference is made to “cable” in the singular sense, it is noted that a cable can actually be made up of plural segments. The surface equipment 106 connected to the at least one fiber optic cable 102 can be a control system (e.g., a computer) deployed on a sea vessel 108 (e.g., a boat or platform) provided at the sea surface 110. The at least one fiber optic cable 102 is provided in an umbilical line 112 that extends from the sea vessel 108. One component can be “connected” to another component by either a direct connection or an indirect connection.

The subsea fiber optic cables 104, 105 are connected to respective underwater systems 114, 115, where the underwater systems include acquisition systems and/or control systems. An acquisition system refers to one or more components used for acquiring or receiving measurements related to operations of a completion string in a subsea wellbore (subsea wellbore 116, 118 in FIG. 1) or measurements made at or above a sea floor 120. A control system refers to one or more components that are used for controlling various aspects of operations of the subsea wellbore, such as controlling production of hydrocarbons, injection of fluids, and so forth. As used here, the term “acquisition/control system” refers to either an acquisition system or a control system, or both. An underwater system can alternatively include other types of systems, such as systems used to connect to underwater marine units (e.g., remote-operated vehicles) and other types of systems.

As depicted, the underwater systems 114, 115 are deployed at or near the sea floor 120. For example, the underwater systems 114, 115 can be mounted to wellhead equipment, such as blowout-preventors (BOPs), riser-connection packages, and so forth.

The subsea optical junction assembly 100 is further connected to another subsea fiber optic cable 124 that is not connected to any underwater equipment. As discussed further below, this fiber optic cable 124 can be used to connect to new underwater equipment that can subsequently be added to the configuration.

In addition to the fiber optic cable 102, the umbilical line 112 also includes other types of control lines (not shown), including hydraulic control lines, electrical cables, and so forth. Although only a single fiber optic cable 102 is depicted, it is noted that the umbilical line 112 can include additional fiber optic cables.

More generally, the subsea optical junction assembly 100 is used to optically couple M fiber optic cables (which are for connection to surface equipment 106) with N subsea fiber optic cables that are connected to underwater systems, where M<N. In this manner, more efficient use is made of the M fiber optic cables in the umbilical line 112 by coupling the M fiber optic cables to a larger number of underwater systems. Note that although only two fiber optic cables 104, 105 and underwater systems 114, 115 are depicted in FIG. 1, other implementations can use a larger number of subsea fiber optic cables and underwater systems.

Sharing of the fiber optic cable 102 in the umbilical line 112 between multiple underwater systems is possible by providing an optical coupler 122 (or multiple optical couplers) with wave-division multiplexing (WDM) circuitry in the subsea optical junction assembly 100. In the upstream direction (from the subsea fiber optic cables 104, 105, 124 to the fiber optic cable 102), the WDM circuitry is used to multiplex optical signals of different wavelengths in the subsea fiber optic cables 114, 115, 124 onto the fiber optic cable 102. Optical signals of different wavelengths can be used by different subsea acquisition/control systems. In the downstream direction (from the fiber optic cable 102 to the subsea fiber optic cables 104, 105, 124), the WDM circuitry in the coupler 122 can demultiplex optical signals of different wavelengths in the fiber optic cable 102 into respective separate optical signals having corresponding different wavelengths, which are provided to fiber optic cables 104, 105, 124. There are several different types of WDM, such as CWDM, DWDM, and so forth, that can be utilized in accordance with some embodiments. The term “WDM” is intended to cover any of the possible WDM types.

By sharing a fiber optic cable in the umbilical line 112 by several (two or more) underwater systems, more efficient usage of the fiber optic cable in the umbilical line 112 is provided, as compared to conventional techniques.

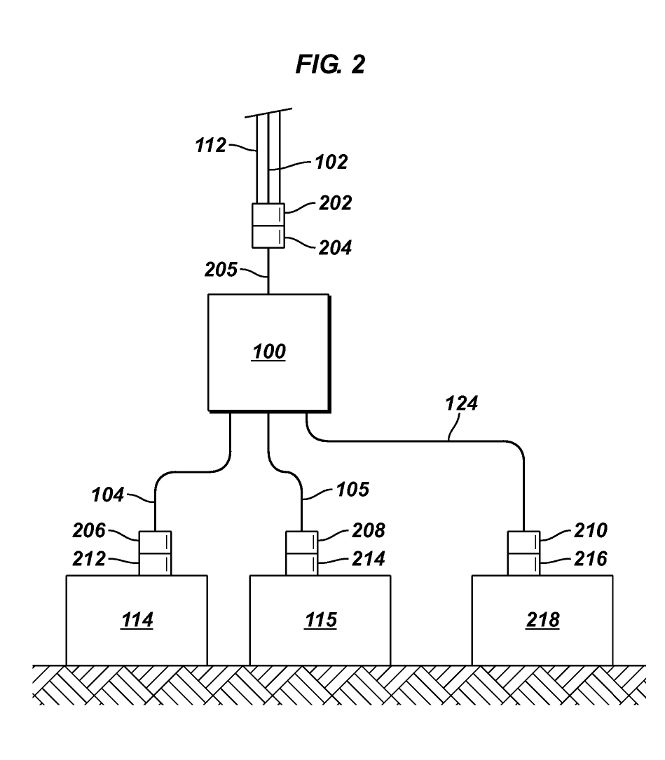

Also, the subsea optical junction assembly 100 makes it more convenient to add new underwater systems that utilize optical communications to the subsea configuration. As noted above, the subsea optical junction assembly 100 includes an initially unused fiber optic cable (e.g., 124 in FIG. 1), or multiple unused fiber optic cables, for enhanced flexibility and convenience. Thus, for example, rather than having to add another umbilical line when a new subsea acquisition/control system is added to the subsea configuration, the new subsea acquisition/control system can simply be connected to an unused subsea fiber optic cable of the subsea optical junction assembly 100, which reduces costs for deploying new subsea optical applications. For example, as shown in FIG. 2, a new underwater system 218 has been added.

FIG. 2 further depicts connectors that can be provided with the subsea optical junction assembly 100 for connecting to various components. For example, the lower end of the umbilical line 112 that contains the fiber optic cable 102 is attached to an umbilical wet mate connector 202. The wet mate connector 202 allows the umbilical line 112 to be connected to a corresponding connector 204 associated with the subsea optical junction assembly 100. The corresponding connector 202 is connected to a fiber optic cable segment 205 that is in turn connected to the subsea optical junction assembly 100. The wet mate connectors 202, 204 allow for connection of fiber optic cables in an underwater environment.

The distal ends of the subsea fiber optic cables 104, 105, and 124 are also provided with wet mate connectors 206, 208 and 210, respectively, for connection to corresponding connectors 212, 214, and 216 of corresponding underwater systems 114, 115, and 218. The underwater system 218 is an example of a new subsea optical application that is added to the configuration after deployment of the umbilical line 112, optical junction assembly 110, and underwater systems 114, 115. As depicted in FIG. 2, the underwater system 218 can be simply connected to the wet mate connector 210 to enable optical communication between the surface equipment 106 and the newly added underwater system 218.

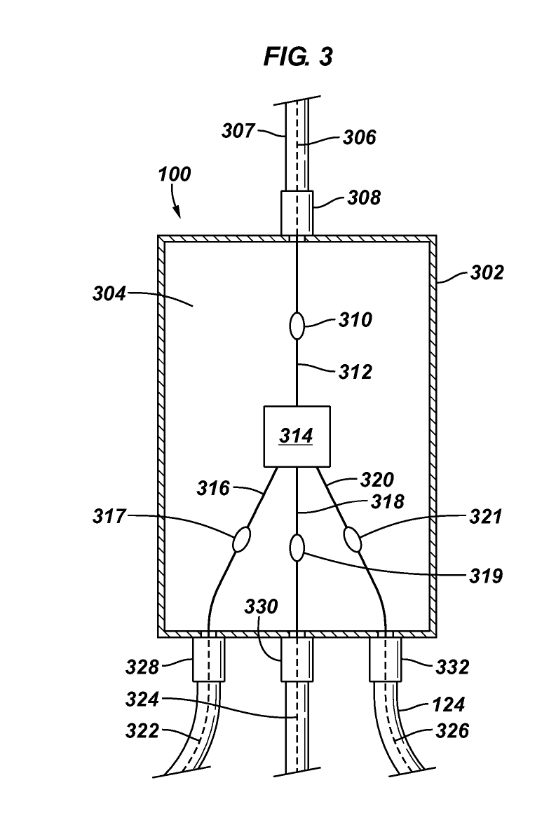

As depicted in FIG. 3, the subsea optical junction assembly 100 according to an embodiment has a housing 302 that defines a sealed enclosure 304. As an example, the sealed enclosure 304 can be a sealed atmospheric chamber (that contains a fluid such as a gas or liquid). As depicted in FIG. 3, an optical fiber 306 in a fiber optic cable 307 passes through a terminal 308 into the sealed enclosure 304. The fiber optic cable 307 can be the fiber optic cable 102 (that is contained in the umbilical line 112) in FIG. 1 or the fiber optic cable 205 from the wet mate connector 204 in FIG. 2. A fusion splice 310 is provided to splice (by fusing) the optic fiber 306 to another optical fiber segment 312. The splice 310 is a splice that melts two optical fibers together. The optical fiber segment 312 is connected to an optical coupler 314.

The optical coupler 314 couples the optical fiber segment 312 to multiple optical fiber segments 316, 318, 320, which are in turn coupled to respective optical fibers 322, 324, 326 by corresponding splices 317, 319, 321. The optical fibers 322, 324, 326 extend into respective fiber optic cables 104, 108 and 124 through respective terminals 328, 330 and 334. As noted above, the optical coupler 314 includes WDM circuitry.

In some implementations, the fiber optic cables 307, 104, 108 and 124 of FIG. 3 can be cables that house oil in respective spaces around corresponding optical fibers 306, 322, 324, 326. Each terminal 308, 328, 330 and 334 provides a seal that permits the corresponding optical fiber to enter the sealed enclosure 304 while preventing oil or sea water from entering the enclosure 304.

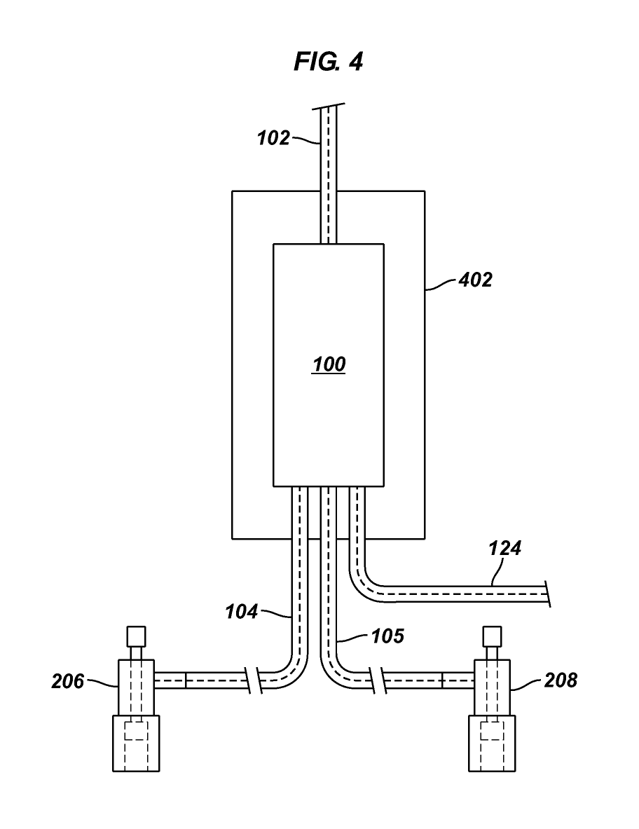

FIG. 4 shows an example arrangement of the subsea optical junction assembly 100 that is mounted to a mounting plate 402 (such as a mounting plate that is part of wellhead equipment). A specific type of wet mate connector 206, 208 is depicted in FIG. 4 to allow wet connection of a corresponding fiber optic cable 104, 105 to underwater systems. The fiber optic cables 104, 105, and 124 that extend from the bottom portion of the optical junction assembly 100 can be oil-filled jumpers to protect the optical fibers in the corresponding fiber optic cables from sea water.

Although only one subsea optical junction assembly 100 is depicted in the figures above, it is noted that in other implementations, additional subsea optical junction assemblies can be provided.

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A system for use in a subsea environment, comprising:
at least one fiber optic cable for connection to surface equipment;
a subsea optical junction assembly connected to the at least one fiber optic cable;
subsea components; and
plural fiber optic cables connected to corresponding subsea components,
wherein the subsea optical junction assembly couples the at least one fiber optic cable for connection with the surface equipment to the plural fiber optic cables connected to the subsea components.

2. The system of claim 1, wherein the at least one fiber optic cable for connection to the surface equipment comprises M fiber optic cables, and the plural fiber optic cables connected to corresponding subsea components comprise N fiber optic cables, where M<N.

3. The system of claim 2, further comprising an umbilical line for extending from a sea vessel to subsea equipment, wherein the M fiber optic cables are provided in the umbilical line.

4. The system of claim 1, wherein the subsea optical junction assembly comprises a housing defining a sealed enclosure.

5. The system of claim 4, wherein the subsea optical junction assembly further comprises at least one optical coupler to optically couple the at least one fiber optic cable to the plural fiber optic cables.

6. The system of claim 5, wherein the subsea optical junction assembly further comprises fusion splices to optically couple the at least one optical coupler to the at least one fiber optic cable and the plural fiber optic cables.

7. The system of claim 4, wherein the subsea optical junction assembly further comprises terminals that enable the at least one fiber optic cable and the plural fiber optic cables to enter the sealed enclosure while keeping water from entering the sealed enclosure.

8. The system of claim 1, further comprising a subsea umbilical line,
wherein the at least one fiber optic cable is in the subsea umbilical line.

9. The system of claim 1, wherein the subsea optical junction assembly further has wet mate connectors coupled to the at least one fiber optic cable and the plural fiber optic cables.

10. The system of claim 9, wherein the subsea components comprise corresponding wet mate connectors to mate with the wet mate connectors coupled to the plural fiber optic cables in an underwater environment.

11. The system of claim 1, wherein the subsea optical junction assembly comprises wave-division multiplexing (WDM) circuitry.

12. A subsea junction assembly comprising:
a housing defining a sealed enclosure;
at least one optical coupler to couple to at least one fiber optic cable that is connected to surface equipment, the at least one optical coupler to further couple to plural fiber optic cables connected to corresponding subsea components,
wherein the optical coupler enables the at least one fiber optic cable to communicate with the plural fiber optic cables.

13. The subsea junction assembly of claim 12, further comprising wet mate connectors coupled to the at least one fiber optic cable and the plural fiber optic cables.

14. The subsea junction assembly of claim 13, further comprising terminals that enable the at least one fiber optic cable and the plural fiber optic cables to enter the sealed enclosure while keeping water from entering the sealed enclosure.

15. The subsea junction assembly of claim 12, wherein the optical coupler comprises wave-division multiplexing (WDM) circuitry.

16. The subsea junction assembly of claim 12, wherein the at least one fiber optic cable connected to the surface equipment comprises M fiber optic cables, and the plural fiber optic cables connected to corresponding subsea components comprise N fiber optic cables, where M<N.

17. The subsea junction assembly of claim 12, wherein the optical coupler is coupled to the at least one fiber optic cable that is deployed in an umbilical line extending through sea water.

18. A method to enable communications in a subsea environment, comprising:
communicating optical signals from a surface equipment at a sea vessel over at least one fiber optic cable to a subsea junction assembly;
coupling, using the subsea junction assembly, the optical signals in the at least one fiber optic cable to plural fiber optic cables; and
communicating the optical signals in the plural fiber optic cables to subsea components deployed underwater.

19. The method of claim 18, wherein the subsea junction assembly has an initially unused fiber optic cable, the method further comprising:
connecting a newly deployed subsea component to the initially unused fiber optic cable; and
communicating optical signals from the at least one fiber optic cable to the newly deployed subsea component through the subsea junction assembly and the initially unused fiber optic cable.

20. The method of claim 19, wherein connecting the newly deployed subsea component is accomplished by use of a wet connection.

21. The method of claim 18, wherein coupling the optical signals is accomplished using an optical coupler having wave-division multiplexing circuitry.
